(19) United States
(12) Patent Application Publication
(10) Pub. No.: US 2020/0173150 A1
(43) Pub. Date: Jun. 4, 2020

(54) WATER OUTLET STRUCTURE CAPABLE OF BEING DISASSEMBLED FOR CLEANING

(71) Applicant: KYLIN SANITARY TECHNOLOGY (XIAMEN) CO., LTD., Xiamen City (CN)

(72) Inventors: ZHI BIN CHEN, XIAMEN CITY (CN); HUI HUANG, XIAMEN CITY (CN); QING SHUANG LI, XIAMEN CITY (TW)

(21) Appl. No.: 16/237,929

(22) Filed: Jan. 2, 2019

(30) Foreign Application Priority Data
Nov. 29, 2018 (CN) 201821984991.1

(51) Int. Cl. E03C 1/04; B01D 35/04; B05B 1/22

(52) U.S. Cl. CPC E03C 1/0404; B01D 35/16; B05B 1/22; B01D 35/04

(57) ABSTRACT

A water outlet structure capable of being disassembled for cleaning comprises an inner core and a core holder. The core holder is hollow. The inner core is inlaid in the core holder to form a jet flow core body. A plurality of water outlet channels are formed between the core holder and the inner core matched with the core holder and are arrayed in the circumferential direction to form circular tracks. An inclined guide side wall and an inclined guide outer wall are formed in each water outlet channel, so an interwoven net-like water pattern or a locally-narrowed water pattern is sprayed out by the water outlet channels. The water outlet channels are formed in the inner core and the core holder so that the water outlet structure can be conveniently disassembled for cleaning when impurities are accumulated in the channels.

### BACKGROUND OF THE INVENTION

### Technical Field

The invention discloses a water outlet structure capable of being disassembled for cleaning, and belongs to the technical field of manufacturing of bathroom water outlet devices in terms of International Patent Classification (IPC).

### Description of Related Art

With the constant improvement of the living standard, people are paying more and more attention to their quality of life. Water nozzles (faucets) are the most common water flow control switches in the daily life. Traditional water nozzles have the drawbacks of high water velocity, large water flow and water splashing in use and have been gradually replaced with novel water nozzles provided with bubblers. As the key element of water nozzles, bubblers have been widely applied to various water nozzles to effectively decrease the water velocity, to avoid water splashing and to save domestic water to a great extent.

Chinese Patent Publication No. CN206343298U discloses a crossed water outlet face cover of a shower. The crossed water outlet face cover of the shower comprises a face cover body, wherein at least two circular water outlet structures are arranged on the face cover body, and each circular water outlet structure is formed by a plurality of water outlet nozzles arranged in the circumferential direction at intervals; water outlets in the water outlet nozzles incline downwards, and the horizontal projections of water columns sprayed out of the water outlet nozzles on the same circular water outlet structure are tangent to a circle in the same rotating direction, and the water columns sprayed out of the water outlet nozzles on every two adjacent circular water outlet structures are crossed. Although a net-like crossed water pattern can be formed by the water outlet nozzles of such structure, the water outlets are integrally designed and are likely to be blocked by impurities, and water channels are inconvenient to clean; and due to the adoption of the integrated oblique water outlets, the face cover is difficult to machine, and the machining cost of the face cover is increased.

### BRIEF SUMMARY OF THE INVENTION

The objective of the invention is to overcome the drawbacks of the prior art by providing an assembled water outlet structure which is reasonable in structure and capable of being disassembled for cleaning and is able to spray out a net-like water pattern, thus, aesthetically improving user experience.

To fulfill the above objective, the following technical solution is adopted by the invention:

A water outlet structure capable of being disassembled for cleaning comprises an inner core and a core holder, wherein the core holder is hollow, the inner core is inlaid in the core holder to form a jet flow core body, a plurality of water outlet channels are formed between the core holder and the inner core matched with the core holder, the water outlet channels are arrayed in the circumferential direction to form circular tracks, an inclined guide side wall is formed in each water outlet channel along the corresponding circular track, and a crossed water pattern is sprayed out by the water outlet channels of the jet flow core body.

Furthermore, each water outlet channel between the core holder and the inner core is provided with a guide outer wall inclining towards the central axis of the core holder, so that a locally-narrowed water pattern is formed along the circular tracks.

Furthermore, a plurality of grooves are formed in the hollow peripheral wall of the core holder, each groove extends towards a water outlet end of the core holder, open sides the grooves are sealed by the outer peripheral wall of the inner core to form the water outlet channels, and a plurality of diversion ports are formed in the peripheral of one end of the inner core.

Furthermore, an inclined guide side wall is formed on one side of each groove of the core holder, an included angle is formed between an extension line of the guide side wall and the longitudinal axis of an inlet of each groove, a guide outer wall is formed at the bottom of each groove, and an extension surface of each guide outer wall extends towards the central axis of the core holder.

Furthermore, matched circular tracks are formed on the radial tangent plane of the inner core and the core holder, a buffer cavity is formed in the middle of the inner core, a convex edge is formed on the periphery of the inner core and is matched with at least one protrusion in the core holder in a positioned manner, a plurality of notches are formed in the periphery of the convex edge to form the diversion ports, and the diversion ports are communicated with the buffer cavity and the water outlet channels.

Furthermore, a water inlet end of the inner core is matched with a water inlet body, a water inlet is formed in the middle of the water inlet body and is communicated with the buffer cavity of the inner core, a peripheral opening of the water inlet body is pressed against the convex edge of the inner core, and a shell is arranged outside the water inlet body, the inner core and the core holder to form a water outlet terminal.

Preferably, one end of the core holder is an outlet end, a plurality of grooves are formed in the peripheral wall of the inner core, open sides of the grooves are sealed by the peripheral wall of the core holder to form the water outlet channels when the core holder is matched with the inner core, and a plurality of diversion ports are formed in the periphery of the inner core.

Furthermore, an inclined guide side wall is arranged in each groove of the inner core, an included angle is formed between an extension line of the guide side wall and the longitudinal axis of an inlet of each groove, side walls, matched with the grooves of the inner core, of the core holder are guide outer walls, and an extension surface of each guide outer wall extends towards the central axis of the core holder.

Furthermore, the inner core is inlaid in the core holder in a matched manner, a buffer cavity is formed in the middle of the inner core, a plurality of notches are formed in the top of the periphery of the inner core to form the diversion ports, the diversion ports penetrate through the wall of the inner core to be communicated with the buffer cavity and the water outlet channels, hanging parts are arranged on two side of each notch of the inner core and are arrayed along the periphery of the inner core, and the hanging parts of the inner core are matched with a convex step on an inner wall of the core holder.

Furthermore, a water inlet end of the inner core is matched with a water inlet body, a water inlet is formed in the middle of the water inlet body and is communicated with the buffer cavity of the inner core, a peripheral opening of the water inlet body is pressed against the hanging parts of the inner core, and a shell is arranged outside the water inlet body, the inner core and the core holder to form a water outlet terminal.

The water outlet channels are formed in the inner core and the core holder so that the water outlet structure can be conveniently disassembled for cleaning when impurities are accumulated in the channels. The water outlet terminal can be matched with a faucet or the like and can spray out an interwoven net-like water pattern or a locally-narrowed water pattern, thereby having good user experience.

### BRIEF DESCRIPTION OF THE SEVERAL VIEWS OF THE DRAWINGS

FIG. 1 is an overall external view of embodiment 1 of the invention.

FIG. 2 is another view of FIG. 1.

FIG. 3 is an exploded view of embodiment 1 of the invention.

FIG. 4 is a horizontal sectional view of water outlet channels in embodiment 1 of the invention.

FIG. 5 is a longitudinal sectional view of the water outlet channels in embodiment 1 in FIG. 1.

FIG. 6 is an external view of embodiment 2 of the invention.

FIG. 7 is an exploded view of embodiment 2 of the invention.

FIG. 8 is a horizontal sectional view of water outlet channels in embodiment 2 of the invention.

FIG. 9 is a longitudinal sectional view of the water outlet channels in embodiment 2 of the invention.

FIG. 10 is a water outlet effect picture of the invention.

### DETAILED DESCRIPTION OF THE INVENTION

The invention is further illustrated below with reference to the accompanying drawings.

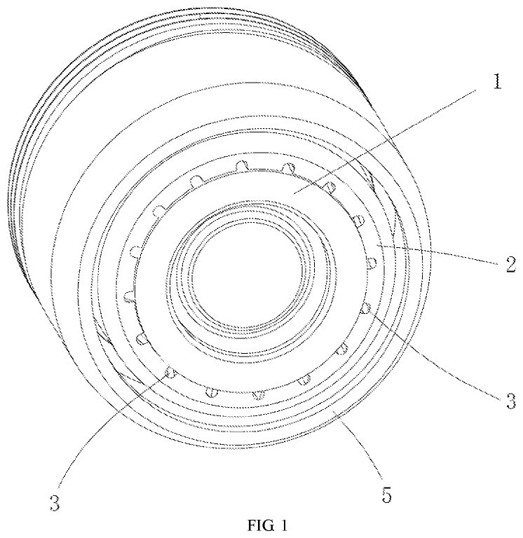

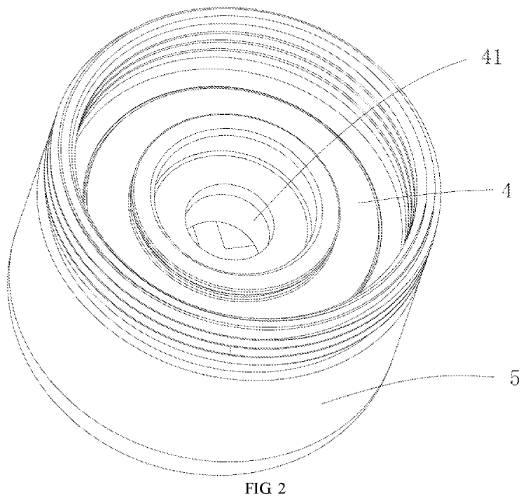

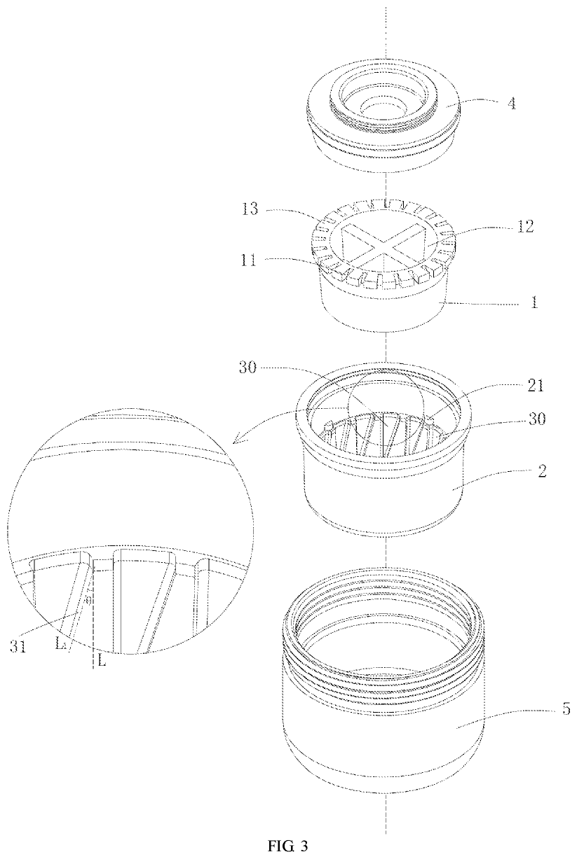

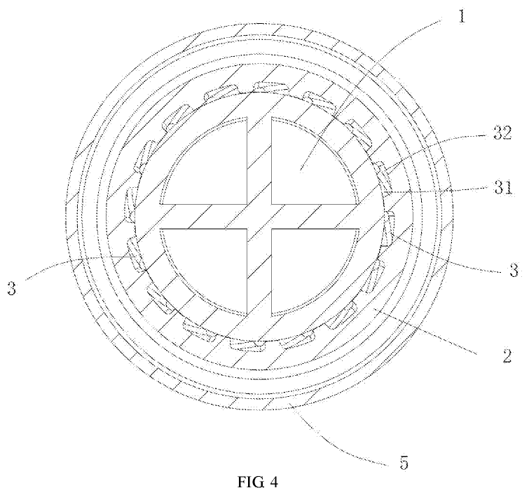

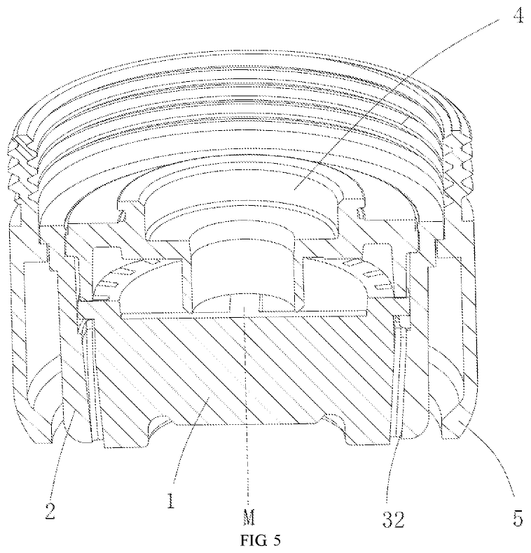

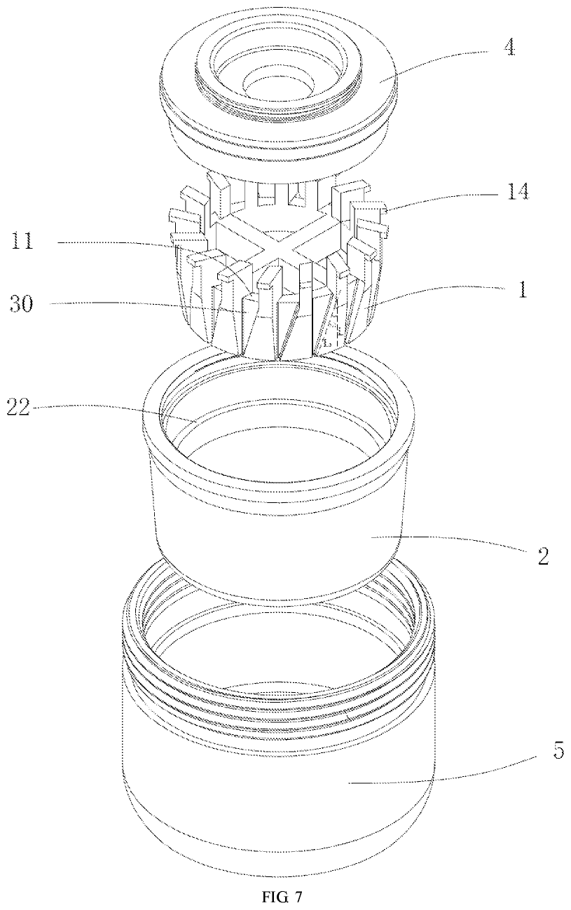

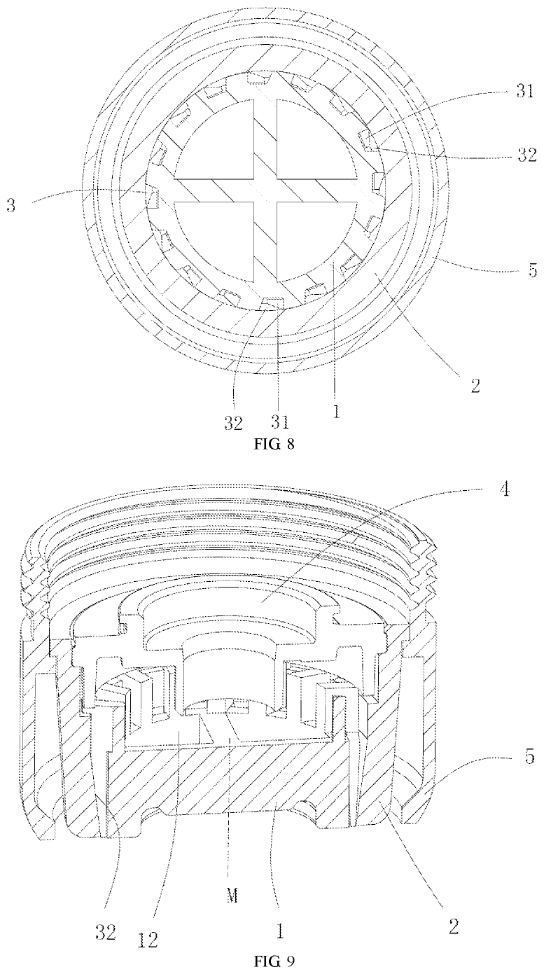

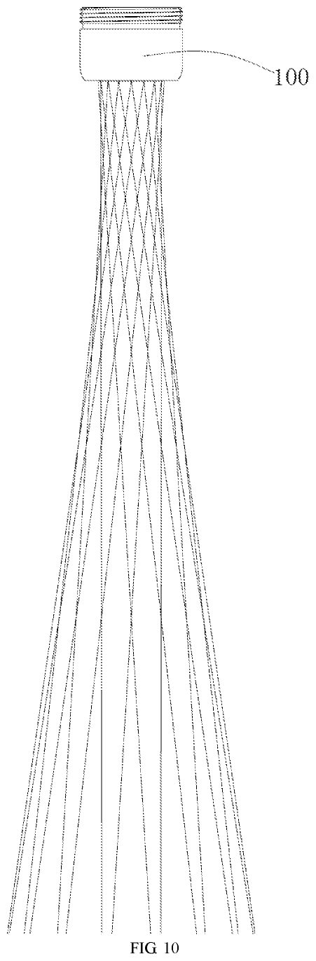

Embodiment: Referring to FIGS. 1-10, a water outlet structure capable of being disassembled for cleaning comprises an inner core 1 and a core holder 2, wherein the core holder 2 is hollow, the inner core 1 is inlaid in the core holder 2 to form a jet flow core body, a plurality of water outlet channels 3 are formed between the core holder 2 and the inner core 1 matched with the core holder 2 and are arrayed in the circumferential direction to form circular tracks, an inclined guide side wall 31 is formed in each water outlet channel along the corresponding circular track, and a crossed water pattern is sprayed out by the water outlet channels 3 of the jet flow core body. Each water outlet channel between the core holder 2 and the inner core 1 is provided with a guide outer wall 32 inclining towards the central axis of the core holder, so that a locally-narrowed water pattern is formed along the circular tracks, as shown in FIG. 10.

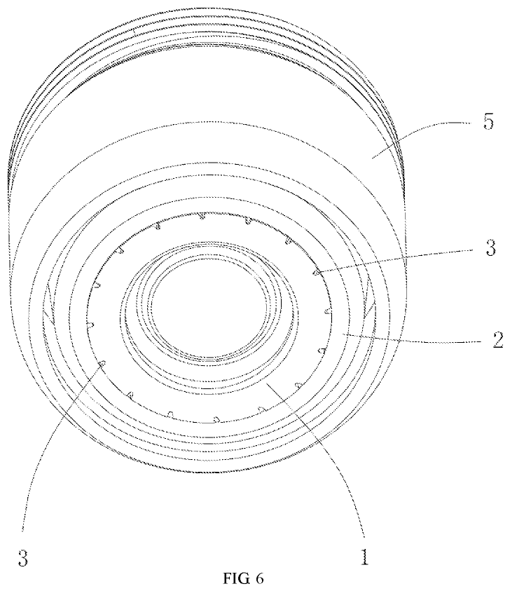

The water outlet structure in this application can be implemented by two embodiments: in one embodiment, the water outlet structure is an outer-groove and inner-wall structure, as shown in FIGS. 1-5; in the other embodiment, the water outlet structure is an outer-wall and inner-groove structure, as shown in FIGS. 6-9.

Referring to FIGS. 1-5, the water outlet channels 3 are located on the core holder 2 as shown in FIG. 1, a plurality of grooves 30 are formed in the hollow peripheral wall of the core holder 2, each groove 30 extends towards a water outlet end of the core holder, and open sides of the grooves are sealed by the outer peripheral wall of the inner core 2 to form the water outlet channels 3; and a plurality of diversion ports 11 are formed in the periphery of one end of the inner core 1, and each diversion port 11 corresponds to one water outlet channel or corresponds to multiple water outlet channels. An inclined guide side wall 31 is arranged on one side of each groove in the core holder 2, and an included angle θ is formed between an extension line L1 of the guide side wall 31 and the longitudinal axis L of an inlet of each groove. When the jet flow core body formed by the inner core 1 and the core holder 2 is circular, the longitudinal axis L of the inlet of each groove is parallel to the central longitudinal axis of the jet flow core body. A guide outer wall 32 is formed at the bottom of each groove, and an extension surface of each guide outer wall 32 extends towards the central axis M of the core holder. The central axis M of the core holder is parallel to the central longitudinal axis of the jet flow core body or is parallel to the central longitudinal axis of a whole water outlet terminal 100. In addition, a side wall, opposite to the corresponding guide side wall 31, in each groove is parallel to the corresponding longitudinal axis L, or an included angle between the side wall, opposite to the corresponding guide side wall 31, in each groove and the corresponding longitudinal axis L is smaller than 0, so that a jet flow sprayed out of each channel is inclined by a certain angle. Matched circular tracks are formed on the radial tangent plane of the inner core 1 and the core holder 2. A buffer cavity 12 is formed in the middle of the inner core 1, and a crossed support is arranged in the buffer cavity 12. A convex edge 13 is formed on the periphery of the inner core land is matched with at least one protrusion in the core holder in a positioned manner. A plurality of notches are formed in the periphery of the convex edge 13 to form the diversion ports 11, and the diversion ports 11 are communicated with the buffer cavity 12 and the water outlet channels 3. A water inlet end of the inner core 1 is matched with a water inlet body 4. A water inlet 41 is formed in the middle of the water inlet body 4 and is communicated with the buffer cavity 12 of the inner core. A peripheral opening of the water inlet body 4 is pressed against the convex edge of the inner core 1. A shell 5 is arranged outside the water inlet body 4, the inner core 1 and the core holder 2 to form the water outlet terminal 100.

Referring to FIGS. 6-9, holes of the water outlet channels 3 are located in the inner core, as shown in FIG. 6. One end of the core holder 2 is an outlet end. A plurality of grooves 30 are formed in the peripheral wall of the inner core 1. When the core holder 2 is matched with the inner core 1, open sides of the grooves are sealed by the peripheral wall of the core holder to form the water outlet channels 3. A plurality of diversion ports 11 are formed in the periphery of the inner core 1. Each diversion port corresponds to one water outlet channel or corresponds to multiple water outlet channels. An inclined guide side wall 31 is formed in each groove of the inner core 1. An included angle ω is formed between an extension line L1 of the guide side wall 31 and the longitudinal axis L of an inlet of each groove. When the jet flow core body formed by the inner core 1 and the core holder 2 is circular, the longitudinal axis L of the inlet of each groove is parallel to the central longitudinal axis of the jet flow core body. Side walls, matched with the grooves of the inner core 1, of the core holder 2 are guide outer walls 32. An extension surface of each guide outer wall 32 extends towards the central axis M of the core holder. The central axis M of the core holder is parallel to the central longitudinal axis of the jet flow core body or is parallel to the central longitudinal axis of a whole water outlet terminal 100. The inner core 1 is inlaid in the core holder 2 in a matched manner. A buffer cavity 12 is formed in the middle of the inner core 1, and a crossed support is arranged in the buffer cavity. A plurality of notches are formed in the top of the periphery of the inner core 1 to form the diversion ports 11. The diversion ports penetrate through the wall of the inner core to be communicated with the buffer cavity 12 and the water outlet channels 3. Hanging parts 14 are arranged on two sides of each notch of the inner core 1 and are arrayed along the periphery of the inner core 1. The hanging parts 14 of the inner core 1 are matched with a convex step 22 on the inner wall of the core holder 2. A water inlet end of the inner core 1 is matched with a water inlet body 4. A water inlet hole 41 is formed in the middle of the water inlet body 4 and is communicated with the buffer cavity 12 of the inner core 1. A peripheral opening of the water inlet body 4 is pressed against the hanging parts 14 of the inner core. A shell 5 is arranged outside the water inlet body 4, the inner core 1 and the core holder 2 to form the water outlet terminal 100.

The invention has the following beneficial effects:

1. The water outlet channels 3 are formed in the inner core 1 and the core holder 2 so that the water outlet structure can be conveniently disassembled to clean the channels.

2. An inlet of the shell 5 is provided with a thread and thus can be conveniently combined with an outlet of a faucet; and the water outlet structure can spray out an interwoven net-like water pattern or a locally-narrowed water pattern as shown in FIG. 10, thereby aesthetically having novelty and good user experience.

The foregoing description only refers to illustrative embodiments of the invention, modifications and alterations achieved by any skilled in this field based on the invention should also fall within the patent scope of the invention, and the patent scope of the invention is not limited to the embodiments disclosed above.

What is claimed is:

1. A water outlet structure capable of being disassembled for cleaning, comprising an inner core and a core holder, wherein the core holder is hollow, the inner core is inlaid in the core holder to form a jet flow core body, a plurality of water outlet channels are formed between the core holder and the inner core matched with the core holder, the water outlet channels are arrayed in a circumferential direction to form circular tracks, an inclined guide side wall is formed in each said water outlet channel along the corresponding circular track, and a crossed water pattern is sprayed out by the water outlet channels of the jet flow core body.

2. The water outlet structure capable of being disassembled for cleaning according to claim 1, wherein each said water outlet channel between the core holder and the inner core is provided with a guide outer wall inclining towards a central axis of the core holder, so that a locally-narrowed water pattern is formed along the circular tracks.

3. The water outlet structure capable of being disassembled for cleaning according to claim 1, wherein a plurality of grooves are formed in a hollow peripheral wall of the core holder, each said groove extends towards a water outlet end of the core holder, open sides the grooves are sealed by an outer peripheral wall of the inner core to form the water outlet channels, and a plurality of diversion ports are formed in a peripheral of one end of the inner core.

4. The water outlet structure capable of being disassembled for cleaning according to claim 2, wherein a plurality of grooves are formed in a hollow peripheral wall of the core holder, each said groove extends towards a water outlet end of the core holder, open sides the grooves are sealed by an outer peripheral wall of the inner core to form the water outlet channels, and a plurality of diversion ports are formed in a peripheral of one end of the inner core.

5. The water outlet structure capable of being disassembled for cleaning according to claim 3, wherein an inclined guide side wall is formed on one side of each said groove of the core holder, an included angle is formed between an extension line of the guide side wall and a longitudinal axis of an inlet of each said groove, a guide outer wall is formed at a bottom of each said groove, and an extension surface of each said guide outer wall extends towards the central axis of the core holder.

6. The water outlet structure capable of being disassembled for cleaning according to claim 3, wherein matched circular tracks are formed on a radial tangent plane of the inner core and the core holder, a buffer cavity is formed in a middle of the inner core, a convex edge is formed on a periphery of the inner core and is matched with at least one protrusion in the core holder in a positioned manner, a plurality of notches are formed in a periphery of the convex edge to form the diversion ports, and the diversion ports are communicated with the buffer cavity and the water outlet channels.

7. The water outlet structure capable of being disassembled for cleaning according to claim 3, wherein a water inlet end of the inner core is matched with a water inlet body, a water inlet is formed in a middle of the water inlet body and is communicated with the buffer cavity of the inner core, a peripheral opening of the water inlet body is pressed against the convex edge of the inner core, and a shell is arranged outside the water inlet body, the inner core and the core holder to form a water outlet terminal.

8. The water outlet structure capable of being disassembled for cleaning according to claim 1, wherein one end of the core holder is an outlet end, a plurality of grooves are formed in a peripheral wall of the inner core, open sides of the grooves are sealed by the peripheral wall of the core holder to form the water outlet channels when the core holder is matched with the inner core, and a plurality of diversion ports are formed in a periphery of the inner core.

9. The water outlet structure capable of being disassembled for cleaning according to claim 2, wherein one end of the core holder is an outlet end, a plurality of grooves are formed in a peripheral wall of the inner core, open sides of the grooves are sealed by the peripheral wall of the core holder to form the water outlet channels when the core holder is matched with the inner core, and a plurality of diversion ports are formed in a periphery of the inner core.

10. The water outlet structure capable of being dissembled for cleaning according to claim 8, wherein an inclined guide side wall is arranged in each said groove of the inner core, an included angle is formed between an extension line of the guide side wall and a longitudinal axis of an inlet of each said groove, side walls, matched with the grooves of the inner core, of the core holder are guide outer walls, and an extension surface of each said guide outer wall extends towards a central axis of the core holder.

11. A water outlet structure capable of being disassembled for cleaning according to claim 10, wherein the inner core is inlaid in the core holder in a matched manner, a buffer cavity is formed in a middle of the inner core, a plurality of notches are formed in a top of the periphery of the inner core to form the diversion ports, the diversion ports penetrate through a wall of the inner core to be communicated with the buffer cavity and the water outlet channels, hanging parts are arranged on two side of each said notch of the inner core and are arrayed along the periphery of the inner core, and the hanging parts of the inner core are matched with a convex step on an inner wall of the core holder.

12. The water outlet structure capable of being disassembled for cleaning according to claim 8, wherein a water inlet end of the inner core is matched with a water inlet body, a water inlet is formed in a middle of the water inlet body and is communicated with the buffer cavity of the inner core, a peripheral opening of the water inlet body is pressed against the hanging parts of the inner core, and a shell is arranged outside the water inlet body, the inner core and the core holder to form a water outlet terminal.
